(19) United States
(12) Patent Application Publication
(10) Pub. No.: US 2007/0283488 A1
(43) Pub. Date: Dec. 13, 2007

(54) Hygiene device

(76) Inventor: Douglas Birdsall, Riverside, CT (US)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/449,512

(22) Filed: Jun. 8, 2006

(51) Int. Cl. A47K 3/022; A61H 35/00; E03C 1/00

(52) U.S. Cl. 4/622

(57) ABSTRACT

A personal hygiene device is provided that integrates a toilet, sink basin, and rinser into a single stand-alone, fully self contained appliance with the sole requirement of needing to be connected to a hot and cold water supply, to a vented waste (sewage) line and/or to an electrical outlet. The device encapsulates the toilet, sink basin, and rinser mechanisms within six walls with a base and ceiling. Entrance to the appliance is gained through a door that when closed forms a water-tight seal. The device can come to the consumer fully assembled and ready to use after making the aforementioned connections. The device is extremely space efficient in that it provides maximum functional capabilities in the usable interior space while consuming a relatively small amount of room area.

### BACKGROUND OF THE INVENTION

1. Field of the Invention

This invention relates to a hygiene device. More specifically, the invention relates to a personal hygiene device that provides a toilet and a rinser (e.g., a movable spraying device).

2. Description of the Related Art

A typical bathroom contains a toilet, sink and shower. Specialty unit bathrooms are known in which various designs are utilized and incorporate toilets, sinks and showers. Such specialty units are designed in various components and require much time and labor in assembling them and permanently installing them into a dwelling.

Portable toilet facilities are also known. Such facilities can be delivered to job sites and the like, but do not provide for a complete range of hygienic services. Moreover, such facilities are not designed for delivery within a room of a home or the like.

Thus, there is a need for a personal hygiene device that provides a toilet and rinser. The device should be easily positionable in a dwelling or other such place, and should be easy to connect to water and waste lines.

### BRIEF SUMMARY OF THE INVENTION

It is an object of the present invention to provide a unitary structure that provides for a full range of hygiene to a user.

It is a further object of the present invention to provide such a system that is mobile.

It is another object of the present invention to provide such a system that is easily connectable to a water supply and a waste line.

A personal hygiene device is provided that comprises a housing having a toilet, a sink, a rinser, a drain, a plumbing conduit and a door. The plumbing conduit is connectable to a supply of hot and cold water and a sewage line. The housing, such as, for example, an interior surface, is water-proof. The housing has a height and a width that permits it to be moved through a door frame into a room.

In another aspect, a personal hygiene device is provided comprising a housing having a toilet, a sink, a rinser, a drain, a plumbing conduit and a door. The plumbing conduit is connectable to a supply of hot water and cold water and a sewage line. The housing is water-proof. The rinser is movable.

In yet another aspect, a method of providing personal hygiene in a room with a hot and cold water supply and a waste line is provided. The method comprises providing a hygiene device with a toilet, a sink, a rinser and a door; moving the hygiene device through a door frame into the room; and connecting the hygiene device to the hot and cold water supply and to the waste line for use of the toilet and the rinser.

The housing can have a width of less than 36″ or less than 30″. The device may further comprise a water tank connected to the toilet. The housing can be sound-proof. The device can further comprise a ventilation system. The device may further comprise a macerator for discharging waste from the device. The device can further comprise mirrors that provide a substantially 360° view of the user.

The method may further comprise providing electrical power to the hygiene device. The method can further comprise sound-proofing an interior of the hygiene device. The method may further comprise ventilating an interior of the hygiene device. The method can further comprise forming a unitary support structure during a manufacturing process that sealingly houses the toilet, sink, and rinser. The method may further comprise pumping waste from the hygiene device to the waste line. The pumping can also be done to a remote waste line including vertically pumping the waste. The method can further comprise reducing fog build up on an interior surface of the hygiene device. The method may further comprise removably connecting the rinser to an interior surface of the hygiene device for showering and exhausting water through a drain in a floor of the hygiene device.

The rinser can be connected to the plumbing conduit via a flexible hose. The device may further comprise a rinser holder positioned along an inner surface of the housing for holding the rinser and a floor being tapered or pitched toward the drain. The device can further comprise an electrical circuit having a light and electrical outlet. The device may further comprise quick-connect members on the plumbing conduit.

### BRIEF DESCRIPTION OF THE DRAWINGS

Other uses and advantages of the present invention will become apparent to those skilled in the art upon reference to the specification and the drawings, in which:

FIG. 1 is a front perspective view of an exemplary embodiment of a personal hygiene device of the present invention with the outer wall shown as transparent for clarity;

FIG. 2 is a rear perspective view of the device of FIG. 1;

FIG. 3 is a top view of the device of FIG. 1;

FIG. 4 is a bottom view of the device of FIG. 1;

FIG. 5 is a first side view of the device of FIG. 1;

FIG. 6 is a second side view of the device of FIG. 1;

FIG. 7 is a perspective view of the device of FIG. 1 with the door and outer wall removed;

FIG. 8 is another perspective view of the device of FIG. 1 with the door and outer wall removed;

FIG. 9 is a top view of the device of FIG. 1 with the top wall removed;

FIG. 10 is a top view of the device of FIG. 1 with the top wall and ceiling removed;

FIG. 11 is a top view of the device of FIG. 1 with the outer wall, top wall, ceiling and ceiling fixtures removed;

FIG. 12 is a top perspective view of the device of FIG. 1 with the outer wall, top wall, ceiling and ceiling fixtures removed;

FIG. 13 is another top perspective view of the device of FIG. 1 with the top wall, ceiling and ceiling fixtures removed;

FIG. 14 is a rear view of the device of FIG. 1 with the door, outer wall and access panel removed;

FIG. 15 is a front view of the device of FIG. 1 with the door, outer wall and access panel removed;

FIG. 15a is a perspective view of the device of FIG. 1 with the door, outer wall, inner wall, base, ceiling and top wall removed;

FIG. 16 is a front perspective view of another exemplary embodiment of a personal hygiene device of the present invention;

FIG. 17 is a bottom view of the device of FIG. 16;

FIG. 18 is a perspective view of the device of FIG. 16 with quick connects attached thereto; and

FIG. 19 is a bottom view of a portion of the device of FIG. 18.

### DETAILED DESCRIPTION OF THE INVENTION

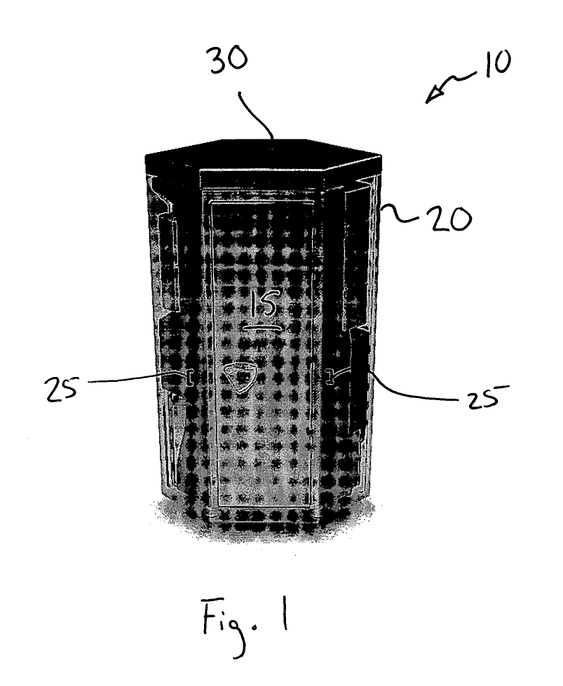

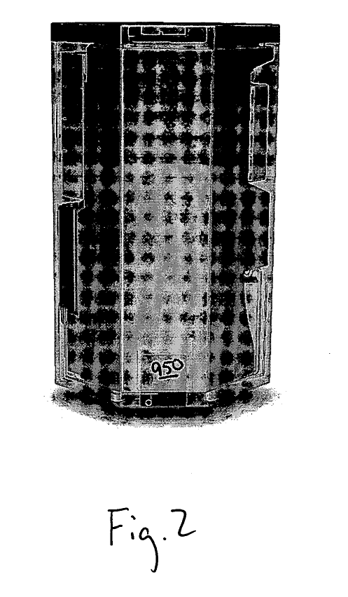

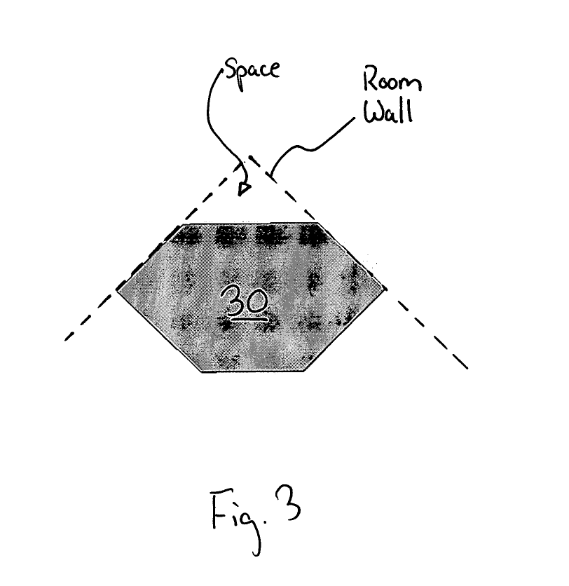

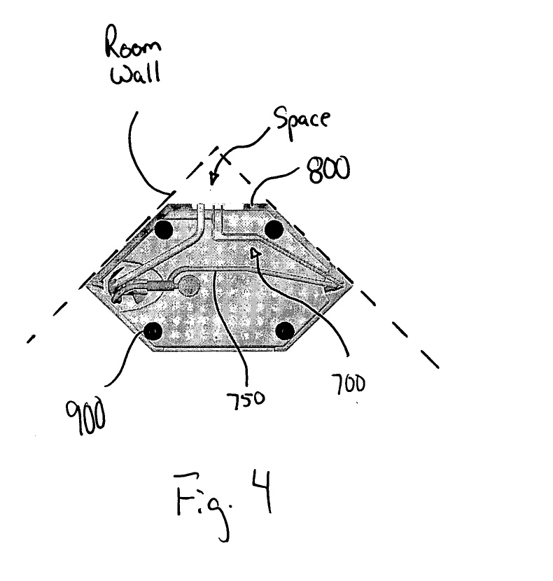

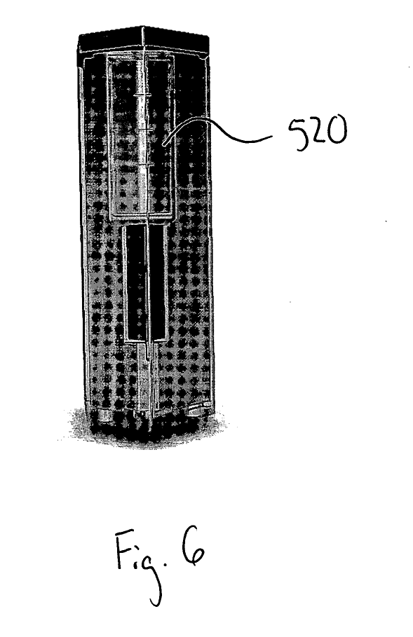

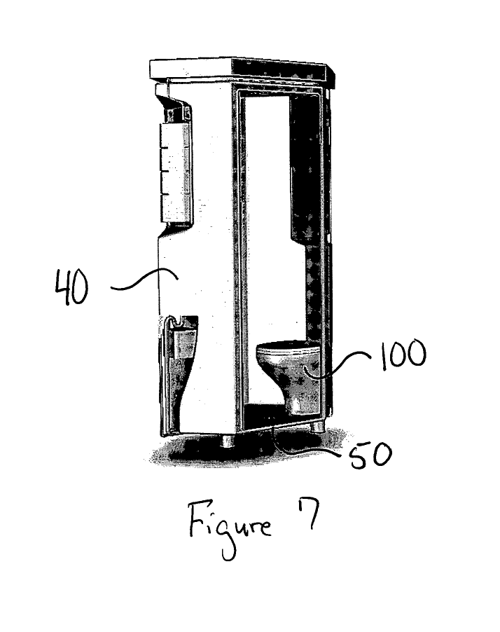

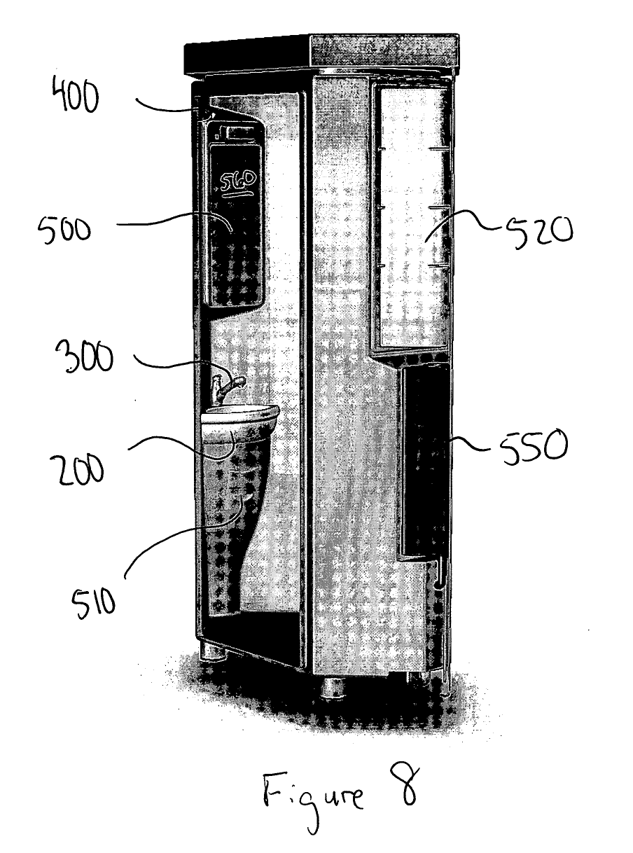

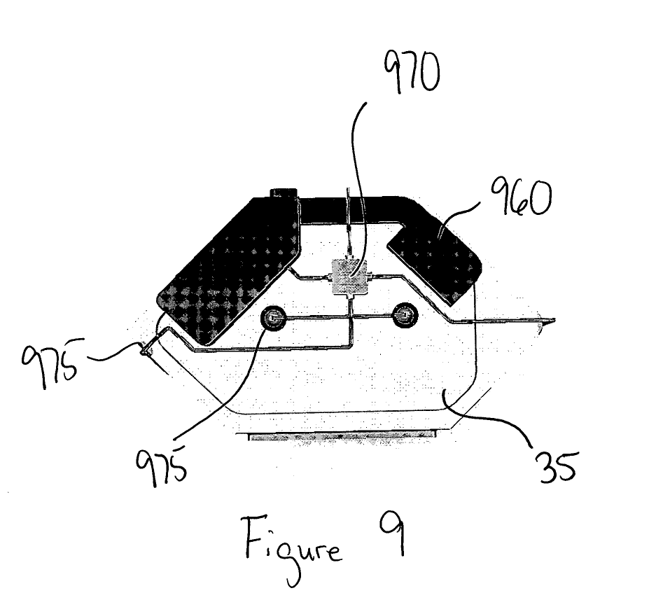

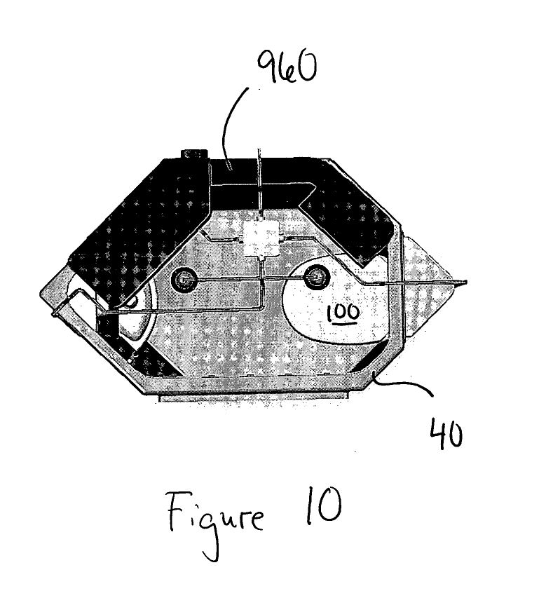

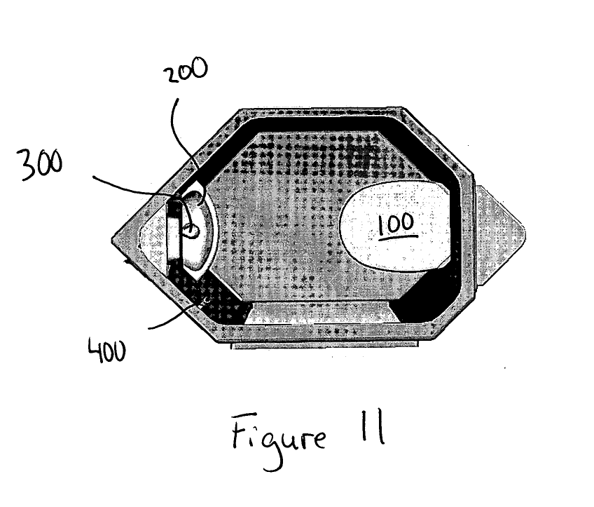

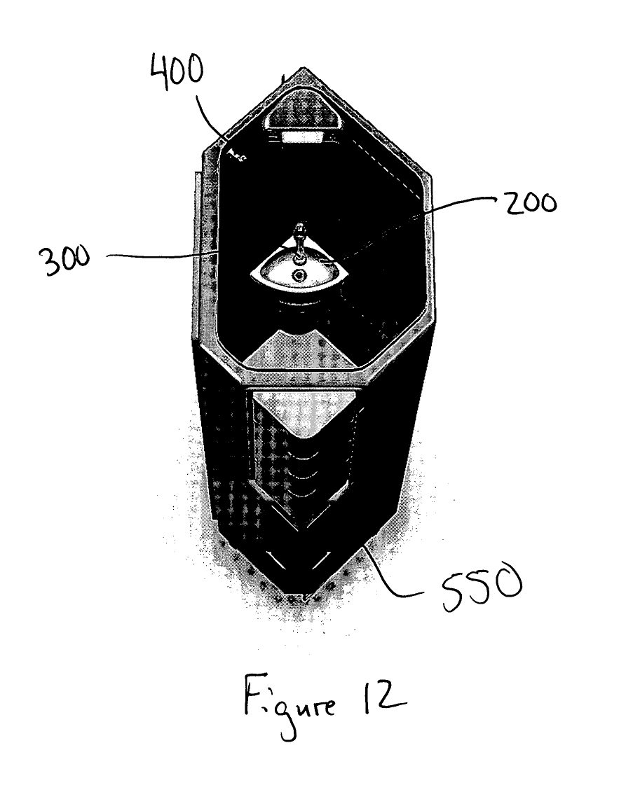

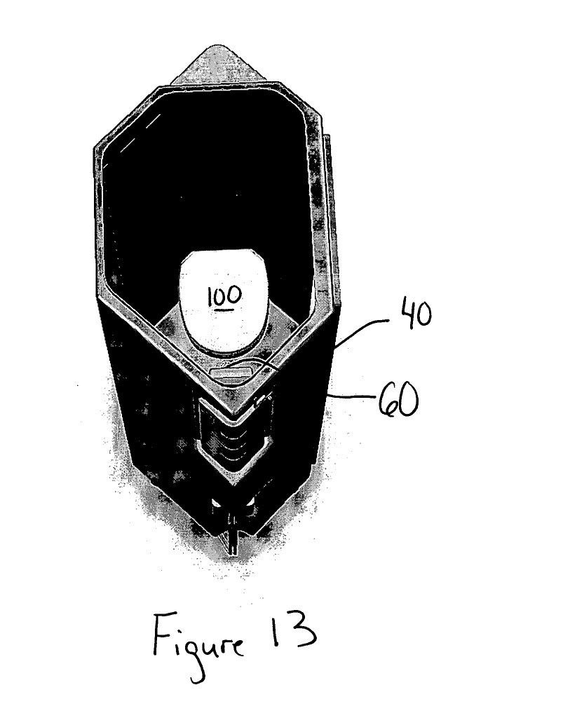

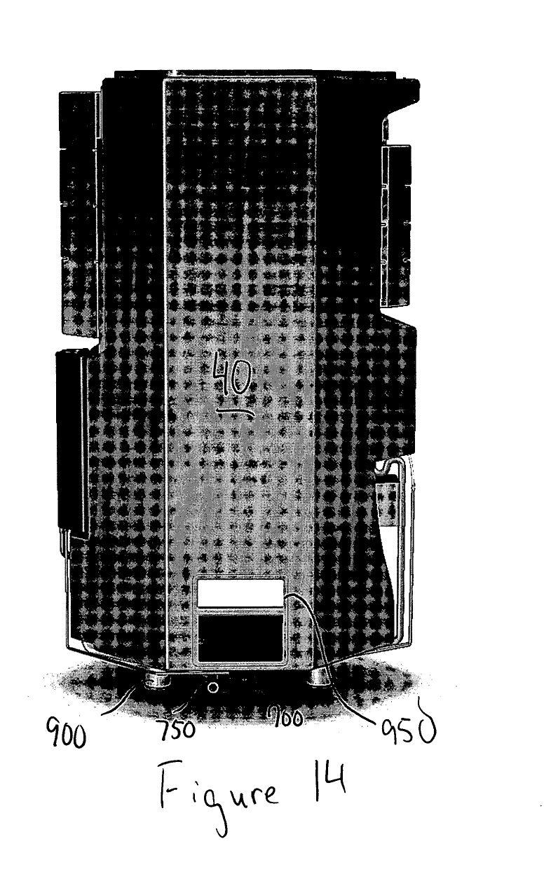

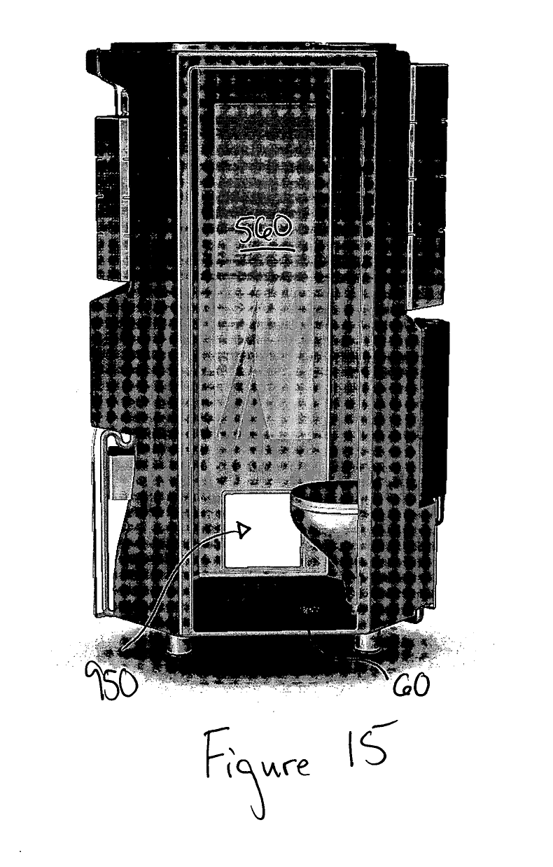

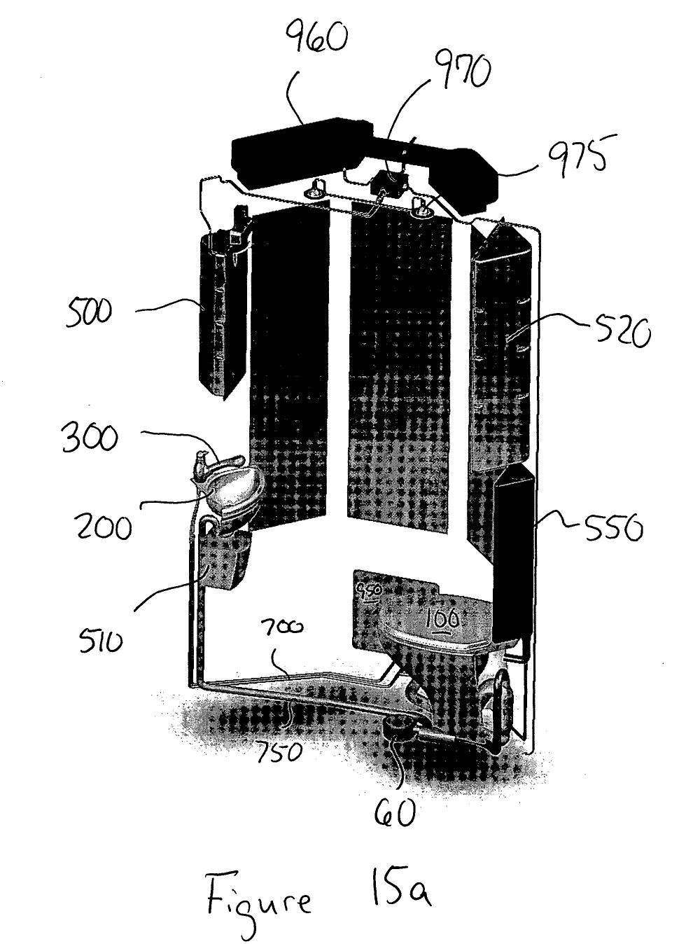

Referring to FIGS. 1 through 15, a personal hygiene device is shown and generally represented by reference numeral 10. Device 10 has a door 15, an outer wall 20, a top wall 30, a ceiling 35, an inner wall 40 and a base 50. In the exemplary embodiment, the device 10 has a hexagonal-like shape (shown clearly in FIGS. 3 and 4) that facilitates positioning of the device in a corner of a room. The shape of device 10 allows abutment of the device against walls of the room, while still allowing a space behind the device for connection of the conduits as will be explained later in more detail. The shape of device 10 maximizes the usefulness of space of the inner volume, while still allowing it to be moved into a room through a doorway as will also be explained later in more detail. However, the present disclosure contemplates other shapes being used for device 10. Preferably, inner wall 40 is made from a one-piece structure to ensure that the device is water-tight.

Device 10 has a toilet 100, a sink 200, a rinser 300 and a hanger 400. Base 50 is provided with a drain 60. The upper surface of the base 50 is tapered or pitched towards the drain 60 at an appropriate angle to allow any water that comes in contact with the base to flow towards the drain. Preferably, the taper is about 2-5°. The rinser 300 is connected to a flexible hose or the like so that the rinser can be moved from its position above the sink 200 to the hanger 400. Any water discharged from the rinser 300 that does not go into the sink will be drained from the base 50 through drain 60. Preferably, hangar 400 is positioned in proximity to the door 15 so that rinser 300 discharges water away from the door to minimize water flow towards the door opening.

The device 10 provides for dry storage of typical hygiene supplies through first, second and third cabinets 500, 510 and 520. Toilet 100 is connected to a water tank 550. Various mirrors 560 can be positioned along the walls and cabinets. Preferably, mirrors 560 are fog-resistant. In an alternative embodiment, the inner walls are substantially all covered by mirrors and are at such an angle so that a user has a substantially complete view (360°) of herself.

To provide for hot and cold water, a water circuit or conduit 700 is provided. Circuit 700 is connected to rinser 300 and water tank 550. Various connectors, valves, flow-control devices and the like can be used to complete the circuit 700. Also, a drain circuit 750 is provided. Drain circuit 750 is connected to the base drain 60, the toilet 100 and the sink 200. Connections for the circuits 700 and 750 are in proximity to a bottom, rear portion 800 of the device 10. Various quick-connect devices and the like can be used for connecting the water circuit 700 and the drain circuit 750 to the plumbing of the room in which the device is being positioned.

The water circuit 700 and the drain circuit 750 preferably run along the bottom surface of the base 50, although the positioning and configuration of these circuits can be varied. To provide space for the water circuit 700 and the drain circuit 750, the base is provided with a number of legs or feet 900 (preferably four). Legs 900 are preferably adjustable in height so that the device 10 can be balanced by the legs. A level can be included along a portion of the device 10 so that a user can ensure that the device is balanced for proper drainage, as well as safety.

An access panel 950 is provided along bottom, rear portion 800 of the device 10. The access panel 950 is preferably a removable portion of the wall that provides a user easy access for connecting the water circuit 700 and the drain circuit 750 to the room's plumbing, but which is easily closed and provides a water-tight seal. While the connections for the water circuit 700 and the drain circuit 750 are provided along bottom, rear portion 800 in this exemplary embodiment, the present disclosure contemplates these connections being positioned elsewhere with respect to device 10. Similarly, access panel 950 can also be positioned elsewhere with respect to device 10 for facilitating connection of the water circuit 700 and the drain circuit 750 to the room's plumbing.

Device 10 has a ventilation system 960 having one or more air purifiers. Various components can be used for purifying the air including fans, filters, plenums and ducts. Device 10 also has an electrical circuit 970 that provides power for various lights 975 positioned in the device, as well as one or more electric outlets positioned in the device. The ventilation system 960 and the electrical circuit 970 are substantially housed in a space along the upper surface of the ceiling 35 under the top wall 30. Although, the present disclosure contemplates the positioning and configuration of the ventilation system 960 and the electrical circuit 970 being varied. Preferably, top wall 30 is easily removable from the device 10 to provide access to the ventilation system 960 and the electrical circuit 970 for replacement of filters and any repairs that may need to be made.

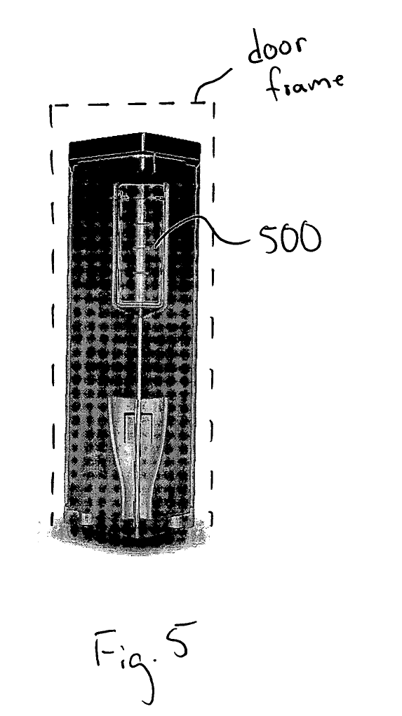

Due to the size and shape of device 10, it can be moved through a door frame as shown in FIG. 5. The hexagonal shape of device 10 maximizes volume, while maintaining a width that can move through a standard door frame. This can be accomplished through use of a hand-truck, dolly, lifting or other moving techniques. Additionally, the device 10 can be provided with wheels that are removably affixed to the base 10 so that the device can be brought through the door frame and positioned in a room, and then secured in place by removing the wheels. Handles 25 can be positioned along outer wall 20 to facilitate moving the device 20. Device 10, including its support structure and components, is preferably made of lightweight material(s) to facilitate moving of the device.

Preferably device 10 has an exterior front-to-back measurement of no greater than about 30″ (preferably 28½″) which allows for it to fit through a standard 30″ doorway without any modification to the appliance or the doorway through which it is passing. A larger version of device 10 with an exterior front-to-back measurement of no greater than 36″ (preferably 34½″) can be moved into rooms through doorways with a width of 36″ without any modification to the appliance or the doorway through which it is passing. Of course, these dimensions can be modified for various geographic regions that have different standard dimensions of door frames. The device 10 can include an anti-tipping device, such as, for example, a bracket that affixes to the wall to prevent tipping over.

The inner surfaces of ceiling 35, inner wall 40 and base 60 are preferably made from, or coated with, a washable, slick and/or waterproof non-porous material, such as, for example, fiberglass reinforced plastic, and/or high density polyethylene. The outer surface of outer wall 20 is preferably a finishing material, such as, for example, a laminate, Formica, wood, metal—such as stainless steel or other such material that might be found in furniture, other appliances or room walls.

Device 10 is preferably substantially sound proof. The soundproofing can be accomplished with various materials, such as, for example, acoustical vinyl barriers, egg crate foam, soundproof foam, acoustical vinyl composite, convoluted acoustical foam, polyamide foam, melamine foam, closed cell acoustical foam and combinations thereof. Such materials can be placed between the outer wall 20 and the inner wall 40. This material can also be placed within the honeycomb structure on the inner wall 40.

Device 10 integrates a toilet, sink basin, and rinser into a single stand-alone, fully self-contained appliance with the sole requirement of needing to be connected to a hot and cold water supply, to a vented waste (sewage) line and to (110 v/120 v) electrical outlet. Device 10 encapsulates the toilet, sink basin, and rinser mechanisms within six walls with a base and ceiling. Entrance to the appliance is gained through a door that when closed forms a water-tight seal. Device 10 preferably comes to the consumer fully assembled and ready to use after making the aforementioned connections. Device 10 is extremely space efficient in that it provides maximum functional capabilities in the usable interior space while consuming a relatively small amount of room area. The device 10 can also have a safety bar or the like to facilitate its use.

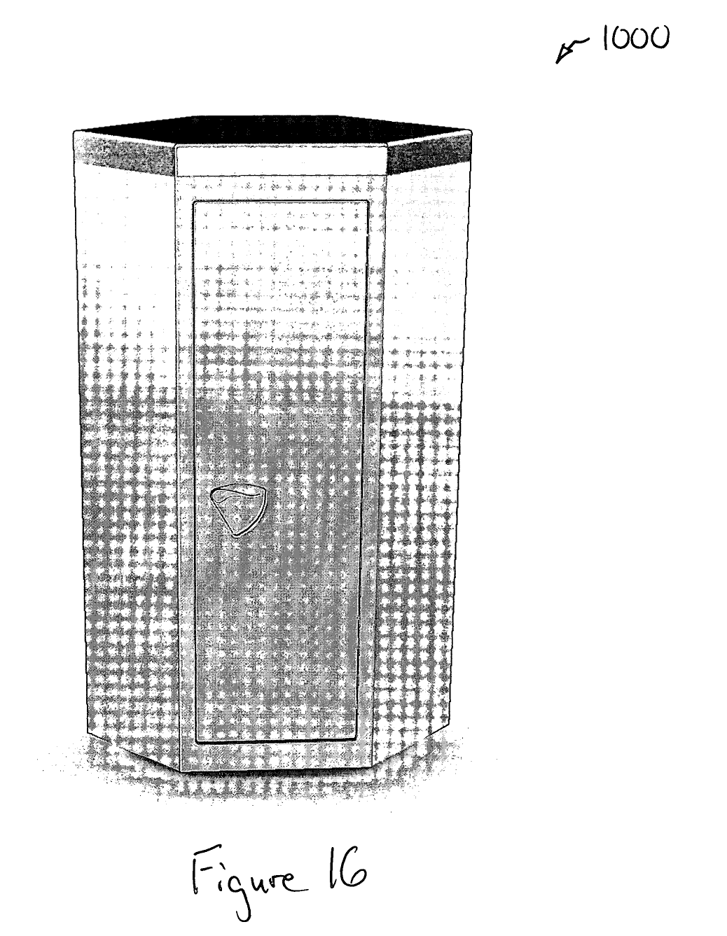

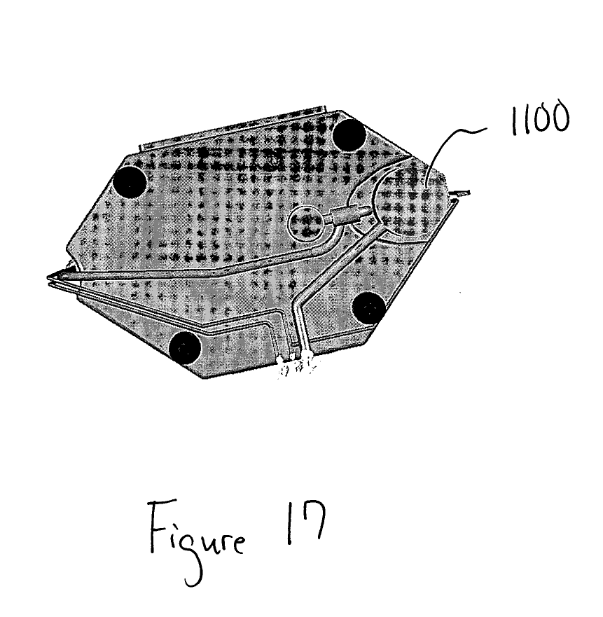

Referring to FIGS. 16 and 17, another exemplary embodiment of the present invention is shown and generally referenced by reference numeral 1000. Device 1000 has many features similar to the features of the embodiment of FIGS. 1 through 15 and the description of which will not be repeated. Device 1000 includes a macerator 1100 that allows for drainage of waste from the toilet and the sink rather than the gravity draining of device 10. In this embodiment, the ends of the plumbing fittings are preferably recessed about 0.25 inches inside of the outer wall to allow for a tight fit against the room wall. However, the fittings can have other end points including being flush with the outer wall.

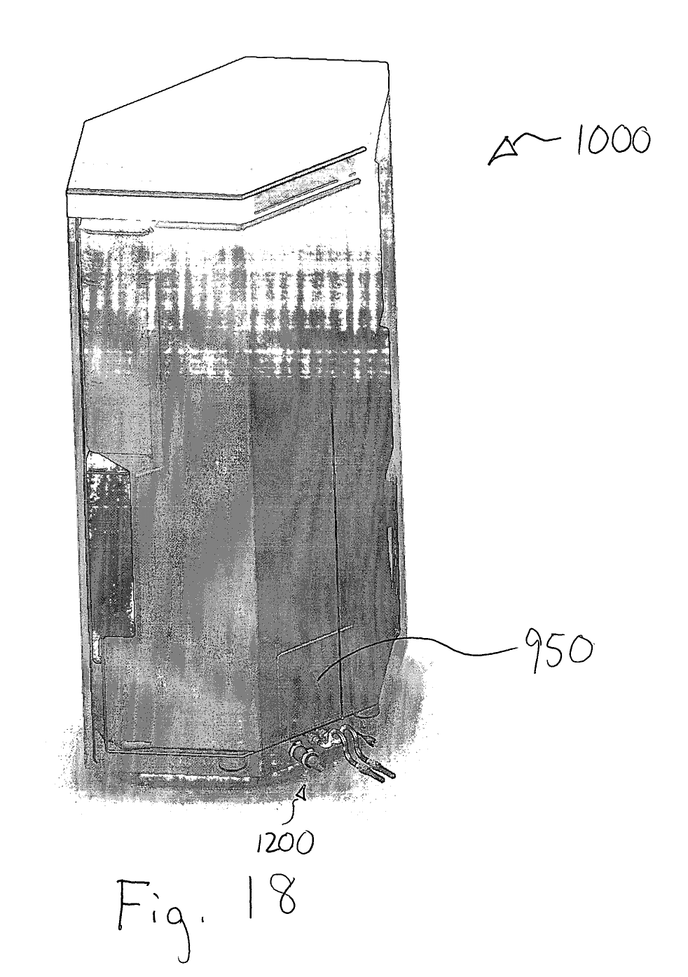

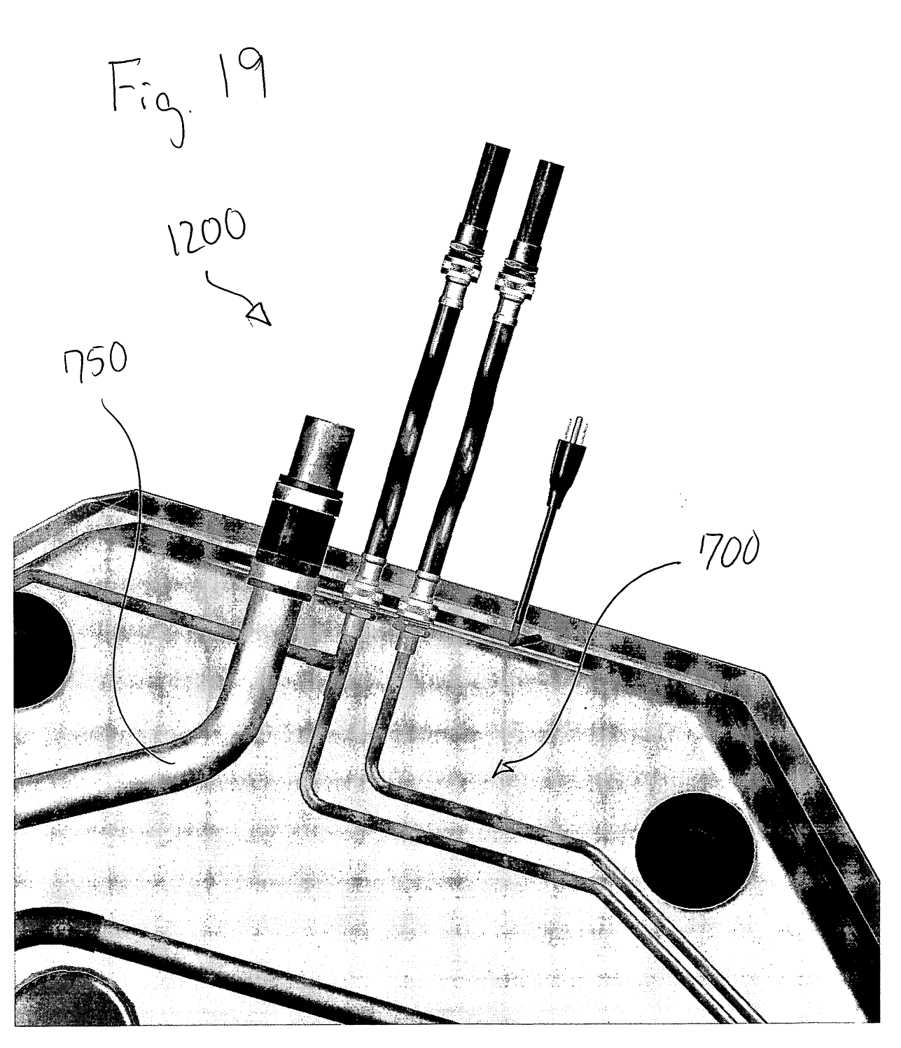

Referring to FIGS. 18 and 19, the device 1000 is shown with quick connect devices 1200 that attach the hot and cold water supply of the building or facility to the water circuit 700, as well as the drain line of the building or facility to the drain circuit 750. Access panel 950 is provided for easy access for connecting the water circuit 700 and the drain circuit 750 to the room's plumbing, but which is easily closed and provides a water-tight seal. The present disclosure also contemplates other connections, such as, for example, threaded connections and ring-clamps, as well as other quick-connect devices and the like being used for connecting the water circuit 700 and the drain circuit 750 to the plumbing of the room in which the device is being positioned. The quick-connect devices 1200 are shown in use with the embodiment of device 1000, but the present disclosure contemplates these devices being used with the other embodiments as well.

The present disclosure also contemplates a portion of the housing being removable, such as, for example, an upper portion of the housing, in order to allow larger devices to be moved through a door frame. Preferably, the electrical circuit and the plumbing conduit would be positioned in only one portion or the other portion so that removal and assembly of the upper portion only require connection of the structure. Various connection devices can be used in this alternative embodiment.

It should be understood by one of ordinary skill in the art that one or more features of the different embodiments can be interchanged with other features of the different embodiments.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

What is claimed is:

1. A method of providing personal hygiene in a room with a hot and cold water supply and a waste line, the method comprising:
providing a hygiene device with a toilet, a sink, a rinser and a door, the hygiene device being self-contained;
moving the hygiene device through a door frame into the room; and
connecting the hygiene device to the hot and cold water supply and to the waste line for use of the toilet and the rinser.

2. The method of claim 1, further comprising providing electrical power to the hygiene device.

3. The method of claim 1, further comprising sound-proofing an interior of the hygiene device.

4. The method of claim 1, further comprising ventilating an interior of the hygiene device.

5. The method of claim 1, further comprising forming a unitary support structure during a manufacturing process that sealingly houses the toilet, sink, and rinser.

6. The method of claim 1, further comprising pumping waste from the hygiene device to the waste line.

7. The method of claim 1, further comprising reducing fog build up on an interior surface of the hygiene device.

8. The method of claim 1, further comprising removably connecting the rinser to an interior surface of the hygiene device for showering and exhausting water through a drain in a floor of the hygiene device.

9. A personal hygiene device comprising:
a housing having a toilet, a sink, a rinser, a drain, a plumbing conduit and a door, the plumbing conduit being connectable to a supply of hot water and cold water and a sewage line, the housing being water-proof, wherein the rinser is movable.

10. The device of claim 9, wherein the rinser is connected to the plumbing conduit via a flexible hose.

11. The device of claim 10, further comprising a rinser holder positioned along an inner surface the housing for holding the rinser and a floor being pitched toward the drain.

12. The device of claim 9, further comprising an electrical circuit having a light and electrical outlet.

13. The device of claim 9, further comprising quick-connect members on the plumbing conduit.

14. A personal hygiene device comprising:
a housing containing a toilet, a sink, a rinser, a drain, a plumbing conduit and a door, the plumbing conduit being connectable to a supply of hot water and cold water and a sewage line, the housing being water-proof, wherein the housing has a height and a width that permits it to be moved through a door frame into a room.

15. The device of claim 14, wherein the housing width is less than 36″.

16. The device of claim 14, further comprising a water tank connected to the toilet.

17. The device of claim 14, wherein the housing is sound-proof.

18. The device of claim 14, further comprising a ventilation system.

19. The device of claim 14, further comprising a macerator for discharging waste from the device.

20. The device of claim 14, further comprising mirrors that provide a substantially 360° view of the user.
